(19) United States
(12) Patent Application Publication
(10) Pub. No.: US 2005/0003721 A1
(43) Pub. Date: Jan. 6, 2005

(54) Joining of different thermoplastic polymers

(76) Inventors: Stefan Greulich, Wilmington, DE (US); Jerome P. Moraczewski, Kennett Square, PA (US); Pallather Manackal Subramanian, Hockessin, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/852,278

(22) Filed: May 24, 2004

Related U.S. Application Data
(60) Provisional application No. 60/536,349, filed on Jan. 14, 2004.
(60) Provisional application No. 60/477,692, filed on Jun. 11, 2003.

(51) Int. Cl. B32B 27/12; B32B 31/20

(52) U.S. Cl. 442/67; 156/308.2

(57) ABSTRACT

Differing thermoplastics may be joined by melt bonding a thermoplastic to one side of a resin sheet having irregular surfaces and melt bonding a different thermoplastic to the other side of the sheet. The bonds obtained are often very strong, resulting in cohesive failure of one of the thermoplastics when one attempts to pull apart the thermoplastics.

### CROSS REFERENCE TO RELATED APPLICATIONS

This application claims the benefit of U.S. Provisional Application No. 60/536,349, filed Nov. 14, 2003, and Application No. 60/477,692, filed Jun. 11, 2003.

### FIELD OF THE INVENTION

Different thermoplastic polymers may be joined together by melt bonding each of the polymers to surfaces of a sheet which has irregular surfaces.

### TECHNICAL BACKGROUND

Thermoplastic polymers (TPs) are important items of commerce, many different types (chemical compositions) and blends thereof being produced for a myriad of uses. Sometimes it is desirable to use two or more different TPs into the same apparatus or part of an apparatus, for example because they have different properties. In many instances it is desirable to join the two (or more) TPs together. Although this may be done by a myriad of methods, for instance mechanical fasteners or snap fit fastening, often the simplest and cheapest method is some sort of bonding process. This may involve use of an adhesive, or a compatibilizing adhesive layer, or simply melting the thermoplastics and contacting them with each other while they are melted. In some cases compatibilizing agents may be added to one or more of the TPs to improve such bonding.

However it is well known that almost all TPs are highly incompatible with one another, and finding an effective adhesive or compatibilizing agent is often daunting, and simply melt bonding to each other almost always doesn't work (little or no bond strength is obtained). Thus in many instances simple and inexpensive methods of bonding different TPs are often not available.

U.S. Pat. No. 4,892,779 describes a multilayer article formed by fusion bonding a microporous polyolefin layer of a specified composition with a nonporous material such as a TP. No mention is made of using the polyolefin layer material to bond two or more different TPs together.

Nonwoven fabrics (NWFs) have also been used to bond other materials together, such as wood and polyethylene, see for instance U.S. Pat. No. 6,136,732 in which a NWF is impregnated with a powdered adhesive which is then bonded to the NWF by melting the adhesive. This sheet may be used to bond “vinyl and/or cloth covering and a variety of surfaces including metal, plastic, rubber and wood.” by melting the adhesive on the NWF. However there is no specific mention of bonding two TPs together.

U.S. Pat. No. 6,544,634 contains an example (Example 19) in which a rubber is “fused” to the surface of a microporous sheet, this assembly is placed into an injection mold with the uncoated side of the microporous sheet exposed, and propylene is injection molded into the mold. There is no disclosure in this patent of joining two different thermoplastics or a thermoplastic and a thermoset resin.

S. Schwarz, et al, in a paper “Mist™ Technology—A New Approach to Interfacial Adhesion”, given at the 4^{th} International Conference “TPOs in Automotive '97”, October 1997, Novi., Ml, report that polypropylene can be molded to both sides of a microporous sheet. No disclosure is made of using such a sheet to join two different thermoplastics.

### SUMMARY OF THE INVENTION

This invention concerns, an article, comprising, a sheet comprising a thermoplastic or crosslinked thermoset resin having a first side and a second side, a first thermoplastic melt bonded to said first side of said sheet, and a second thermoplastic melt bonded to said second side of said sheet, and
provided that:
   said first side and said second side have irregular surfaces; and
   said first thermoplastic and said second thermoplastic are different.

This invention also concerns a process for forming an article in which a first thermoplastic and a second thermoplastic are bonded to each other, comprising:
(a) melt bonding said first thermoplastic to a first side of a sheet comprising a crosslinked thermoset or thermoplastic resin; and
(b) melt bonding said second thermoplastic to a second side of said sheet;
provided that:
   said first side and said second side have irregular surfaces; and
   said first thermoplastic and said second thermoplastic are different.

### BRIEF DESCRIPTION OF THE DRAWING

The invention will be more fully understood from the following detailed description, taken in connection with the accompanying drawings, in which:

FIG. 1 shows an embodiment of the present invention of injection molded parts used in forming assemblies for weld joining and burst pressure testing.

FIG. 2 shows an enlarged view of the mating surfaces of FIG. 1.

While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims.

### DETAILS OF THE INVENTION

The following definitions are provided as reference in accordance with how they are used in the context of this specification and the accompanying claims:

“Sheet” means a material shape in which two of the surfaces have at least about twice, more preferably at least about 10 times, the surface areas of any of the other exterior surfaces. Included in this definition would be a sheet with the dimensions 15 cm×15 cm×0.3 cm thick, and a film 15 cm×15 cm×0.2 mm thick. The latter (which is often called a film) in many instances will be flexible and may be drapeable, so that is can be adapted to conform to irregular surfaces. Preferably the sheet has a minimum thickness of about 0.03 mm, more preferably about 0.08 mm, and especially preferably about 0.13 mm. Preferably the sheet has a maximum thickness of about 0.64 mm, more preferably about 0.38 mm, and especially preferably about 0.25 mm. It is to be understood that any preferred minimum thickness can be combined with any preferred maximum thickness to form a preferred thickness range.

“Irregular surface” means that the surface has irregularities in or on it that will aid in mechanically locking to it any molten material which flows into or onto the surface and the irregularities thereon, and when the molten material subsequently solidifies it causes the material to be mechanically locked (i.e. bonded) to the irregular surface.

“Resin” means any polymeric material, whether of natural or manmade (synthetic) origin. Synthetic materials are preferred.

“Irregular surface sheet (ISS)” means a sheet having an “irregular surface”.

“Melt bonding” means the TP is melted where “melted” means that a crystalline TP is heated to about or above its highest melting point, while an amorphous thermoplastic is melted above its highest glass transition temperature. While melted the TP is placed in contact with an appropriate surface of the ISS. During this contact, usually some pressure (i.e. force) will be applied to cause the TP to flow onto and perhaps penetrate some of the pores or irregularities on the surface of the ISS. The TP is then allowed to cool, or otherwise become solid.

“Thermoplastic” (TP) is material that is meltable before and while being melt bonded to the ISS, but in their final form are solids, that is they are crystalline or glassy (and therefore typical elastomers, whose melting points and/or glass transition temperature, if any, are below ambient temperature, are not included in TPs, but thermoplastic elastomers are included in TPs). Thus this can mean a typical (i.e. “classical”) TP polymer such as polyethylene. It can also mean a thermosetting polymer before it thermosets (e.g. crosslinks), that is, while it can be melted and flows in the molten state. Thermosetting may take place after the melt bonding has taken place, perhaps in the same apparatus where the melt bonding took place, and perhaps by simply further heating of the thermoset resin, to form a resin which is glassy and/or crystalline. Useful thermoplastic elastomers include block copolyesters with polyether soft segments, styrene-butadiene block copolymers, and thermoplastic polyurethanes.

By TPs being “different” is meant that they have a different chemical composition. Examples of different thermoplastics include: polyethylene (PE) and polypropylene; polystyrene and poly(ethylene terephthalate) (PET); nylon-6,6 and poly(1,4-butylene terephthalate; nylon-6,6 and nylon-6; polyoxymethylene and poly(phenylene sulfide); poly(ethytene terephthalate) and poly(butylene terephthalate); poly(ether-ether-ketone) and poly(hexafluoropropylene)(perfluoromethyl vinyl ether) copolymer); a thermotropic liquid crystalline polyester and a thermosetting epoxy resin (before crosslinking); and a thermosetting melamine resin (before crosslinking) and a thermosetting phenolic resin (before crosslinking). Different thermoplastics may also include blends of the same thermoplastics but in different proportions, for example a blend of 85 weight percent PET and 15 weight percent PE is different than a blend of 35 weight percent PET and 65 weight percent PE. Also, different includes differing the presence and/or amount of other comonomers, for example PET is different than poly(ethylene isophthalate/terephthalate).

“Bonded” herein is meant the materials attached to one another, in most instances herein permanently, and/or with the ISS between the materials. Typically no other adhesives or similar materials are used in the bonding process, other than the ISS.

The ISS sheet may have irregular surfaces formed in many ways. It may be: a fabric, for instance woven, knitted or nonwoven; a paper; foamed, particularly an open cell foam and/or a microcellular foam; a sheet with a roughened surface formed by for example sandblasting or with an abrasive such as sandpaper or sharkskin; and a microporous sheet (MPS). Preferred forms of ISS are fabrics, especially nonwoven fabrics (NWFs), and microporous sheets (MPSs).

“Microporous” means a material, usually a thermoset or thermoplastic polymeric material, preferably a thermoplastic, which is at least about 20 percent by volume, more preferably at least about 35% by volume pores. Often the percentage by volume is higher, for instance about 60% to about 75% by volume pores. The porosity is determined according to the equation:
“Porosity”=100(1−d₁/d₂)
wherein d₁ is the actual density of the porous sample determined by weighing a sample and dividing that weight by the volume of the sample, which is determined from the sample's dimensions. The value d₂ is the “theoretical” density of the sample assuming no voids or pores are present in the sample, and it determined by known calculations employing the amounts and corresponding densities of the samples ingredients. More details on the calculation of the porosity may be found in U.S. Pat. No. 4,892,779, which is hereby incorporated by reference. Preferably the microporous material has interconnecting pores.

The MPS herein may be made by methods described in U.S. Pat. Nos. 3,351,495, 4,698,372, 4,867,881, 4,874,568, and 5,130,342, all of which are hereby included by reference. A preferred microporous sheet is described in U.S. Pat. No. 4,892,779, which is hereby included by reference. Similar to many microporous sheets those of this patent have a high amount of a particulate material (filler). This particular type of sheet is made from polyethylene, much of which is a linear ultrahigh molecular weight polymer.

“Fabric” is a sheet-like material made from fibers. The materials from which the fibers are made may be synthetic (man-made) or natural. The fabric may be a woven fabric, knitted fabric or a nonwoven fabric, and nonwoven fabrics are preferred. Useful materials for the fabrics include cotton, jute, cellulosics, wool, glass fiber, carbon fiber, poly(ethylene terephthalate), polyamides such as nylon-6, nylon-6,6, and aromatic-aliphatic copolyamides, aramids such as poly(p-phenylene terephthalamide), polypropylene, polyethylene, thermotropic liquid crystalline polymer, fluoropolymers and poly(phenylene sulfide).

The fabric herein can be made by any known fabric making technique, such as weaving or knitting. However a preferred fabric type is a NWF. NWFs can be made by methods described in 1. Butler, The Nonwoven Fabrics Handbook, Association of the Nonwoven Fabrics Industry, Cary, N.C., 1999, which is hereby included by reference. Useful types of processes for making NWFs for this invention include spunbonded, and melt blown. Typically the fibers in the NWF will be fixed in some relationship to each other. When the NWF is laid down as a molten TP (for example spunbonded) the fibers may not solidify completely before a new fiber layer contacts the previous fiber layer thereby resulting in partial fusing together of the fibers. The fabric may be needled or spunlaced to entangle and fix the fibers, or the fibers may be thermally bonded together.

The characteristics of the fabric to some extent determines the characteristics of the bond(s) between the TPs to be joined. Preferably the fabric is not so tightly woven that melted TP has difficulty (under the melt bonding condition used) penetrating into and around the fibers of the fabric. Therefore it may be preferable that the fabric be relatively porous. However, if the fabric is too porous it may form bonds which are too weak. The strength and stiffness of the fabric (and in turn the fibers used in the fabric) may determine to some extent the strength and other properties of the bond(s) formed. Higher strength fibers such as carbon fiber or aramid fibers therefore may be advantageous in some instances.

Without being held to theory, it is believed that the thermoplastics may bond to the surfaces of the ISS sheet (at least in part) by mechanical locking of the TP to the ISS sheet. It is believed that during the melt bonding step the TP “penetrates” the irregularities on the surface, or actually below or through the surface through pores, voids and/or other channels (if they exist). When the TP solidifies, it is mechanically locked into and/or onto these irregularities and, if present, pores, voids and/or other channels.

One type of preferred material for the first and/or second TP is a “classical” TP, that is a material that is not easily crosslinkable, and which has a melting point and/or glass transition temperature above about 30° C. Preferably, if such a classical TP is crystalline, it has a crystalline melting point of 50° C. or more, more preferably with a heat of fusion of 2 J/g or more, especially preferably 5 J/g or more. If the TP is glassy it preferably has a glass transition point of 50° C. or more. In some instances the melting point or glass transition temperature may be so high that the TP decomposes before reaching that temperature. Such polymers are also included herein as TPs. Melting points and glass transition temperatures are measured using ASTM Method ASTM D3418-82. The melting point is taken as the peak of the melting endotherm, and the glass transition temperature is taken at the transition midpoint.

Such classical TPs include: poly(oxymethylene) and its copolymers; polyesters such as PET, poly(1,4-butylene terephthalate), poly(1,4-cyclohexyldimethylene terephthalate), and poly(1,3-poropyleneterephthalate); polyamides such as nylon-6,6, nylon-6, nylon-12, nylon-11, and aromatic-aliphatic copolyamides; polyolefins such as polyethylene (i.e. all forms such as low density, linear low density, high density, etc.), polypropylene, polystyrene, polystyrene/poly(phenylene oxide) blends, polycarbonates such as poly(bisphenol-A carbonate); fluoropolymers including perfluoropolymers and partially fluorinated polymers such as copolymers of tetrafluoroethylene and hexafluoropropylene, poly(vinyl fluoride), and the copolymers of ethylene and vinylidene fluoride or vinyl fluoride; polysulfides such as poly(p-phenylene sulfide); polyetherketones such as poly(ether-ketones), poly(ether-ether-ketones), and poly(ether-ketone-ketones); poly(etherimides); acrylonitrile-1,3-butadinene-styrene copolymers; thermoplastic (meth)acrylic polymers such as poly(methyl methacrylate); thermoplastic elastomers such as the “block” copolyester from terephthalate, 1,4-butanediol and poly(tetramethyleneether)glycol, and a block polyolefin containing styrene and (hydrogenated) 1,3-butadiene blocks; and chlorinated polymers such as poly(vinyl chloride), vinyl chloride copolymer, and poly(vinylidene chloride). Polymers which may be formed in situ, such as (meth)acrylate ester polymers are also included.). Any of the types of TPs in this listing may be joined with any other type of TP in this listing in the process described herein, to make a preferred assembly. Polymer from a single type (for example the polyolefins polyethylene and polypropylene) may be joined together in the instant process, as long as the two polymers are chemically distinct. In one form, it is preferred that one or both of the first and second TPs are classical TPs.

Useful pairs of TPs to be joined using the ISS include:
polyoxymethylene homo- and copolymers with a polymer selected from the group consisting of a polyolefin (especially polyethylene and its copolymers, polypropylene and its copolymers, and polystyrene), a poly(meth)acrylate [especially poly(methyl methacrylate)], a polycarbonate, a fluorinated polymer (especially perfluoropolymers), a polyester [especially poly(ethylene terephthalate), poly(1,3-propylene) terephthalate), poly(1,4-butylene terephthalate), poly(1,6-cychexylenendimethanol terephthalate), and poly(ethylene 1,6-napthalate)], and copolymers of all of these], a polyamide (especially nylon 6,6, nylon-6, and poly(1,4-phenylene terephthalamide), and copolymers of any of these], a thermotropic liquid crystalline polymer, a polysulfone, a polysulfide, a polyketone (including polyketones containing ether linking groups), an acrylonitrile-butadiene-styrene (ABS) copolymer, a chlorinated polymer [especially poly(vinyl chloride) and poly(vinylidene chloride)], and a thermoplastic elastomer, especially a thermoplastic block co(polyester-polyether), a block copolyolefin, a thermoplastic urethane or a thermoplastic elastomeric polymer blend;
a polyester [especially poly(ethylene terephthalate), poly(1,3-propylene) terephthalate), poly(1,4-butylene terephthalate), poly(1,6-cychexylenendimethanol terephthalate), and poly(ethylene 1,6-napthalate)], and copolymers of all of these], with a polymer selected from the group consisting of a polyolefin (especially polyethylene and its copolymers, polypropylene and its copolymers, and polystyrene), a poly(meth)acrylate [especially poly(methyl methacrylate)], a polycarbonate, a fluorinated polymer (especially perfluoropolymers), a (different) polyester [especially poly(ethylene terephthalate), poly(1,3-propylene) terephthalate), poly(1,4-butylene terephthalate), poly(1,6-cychexylenendimethanol terephthalate), and poly(ethylene 1,6-napthalate)], and copolymers of all of these], a polyamide (especially nylon 6,6, nylon-6, and poly(1,4-phenylene terephthalamide), and copolymers of any of these], a thermotropic liquid crystalline polymer, a polysulfone, a polysulfide, a polyketone (including polyketones containing ether linking groups), an acrylonitrile-butadiene-styrene (ABS) copolymer, a chlorinated polymer [especially poly(vinyl chloride) and poly(vinylidene chloride)], and a thermoplastic elastomer, especially a thermoplastic block co(polyester-polyether), a block copolyolefin, a thermoplastic urethane or a thermoplastic elastomeric polymer blend;
a polyamide (especially nylon 6,6, nylon-6, and poly(1,4-phenylene terephthalamide), with a polymer selected from the group consisting of a polyolefin (especially polyethylene and its copolymers, polypropylene and its copolymers, and polystyrene), a poly(meth)acrylate [especially poly(methyl methacrylate)], a polycarbonate, a fluorinated polymer (especially perfluoropolymers), a polyester [especially poly(ethylene terephthalate), poly(1,3-propylene) terephthalate), poly(1,4-butylene terephthalate), poly(1,6-cychexylenendimethanol terephthalate), and poly(ethylene 1,6-napthalate)], and copolymers of all of these], a (different) polyamide (especially nylon 6,6, nylon-6, and poly(1,4-phenylene terephthalamide), and copolymers of any of these], a thermotropic liquid crystalline polymer, a polysulfone, a polysulfide, a polyketone (including polyketones containing ether linking groups), an acrylonitrile-butadiene-styrene (ABS) copolymer, a chlorinated polymer [especially poly(vinyl chloride) and poly(vinylidene chloride)], and a thermoplastic elastomer, especially a thermoplastic block co(polyester-polyether), a block copolyolefin, a thermoplastic urethane or a thermoplastic elastomeric polymer blend;
a thermotropic liquid crystalline polymer with a polymer selected from the group consisting of a polyolefin (especially polyethylene and its copolymers, polypropylene and its copolymers, and polystyrene), a poly(meth)acrylate [especially poly(methyl methacrylate)], a polycarbonate, a fluorinated polymer (especially perfluoropolymers>, a polyester [especially poly(ethylene terephthalate), poly(1,3-propylene) terephthalate), poly(1,4-butylene terephthalate), poly(1,6-cychexylenendimethanol terephthalate), and poly(ethylene 1,6-napthalate)], and copolymers of all of these], a polyamide (especially nylon 6,6, nylon-6, and poly(1,4-phenylene terephthalamide), and copolymers of any of these], a (different) thermotropic liquid crystalline polymer, a polysulfone, a polysulfide, a polyketone (including polyketones containing ether linking groups), an acrylonitrile-butadiene-styrene (ABS) copolymer, a chlorinated polymer [especially poly(vinyl chloride) and poly(vinylidene chloride)], and a thermoplastic elastomer, especially a thermoplastic block co(polyester-polyether), a block copolyolefin, a thermoplastic urethane or a thermoplastic elastomeric polymer blend; or
a fluorinated polymer with a polymer selected from the group consisting of a polyolefin (especially polyethylene and its copolymers, polypropylene and its copolymers, and polystyrene), a poly(meth)acrylate [especially poly(methyl methacrylate)], a polycarbonate, a (different) fluorinated polymer (especially perfluoropolymers), a polyester [especially poly(ethylene terephthalate), poly(1,3-propylene) terephthalate), poly(1,4-butylene terephthalate), poly(1,6-cychexylenendimethanol terephthalate), and poly(ethylene 1,6-napthalate)], and copolymers of all of these], a polyamide (especially nylon 6,6, nylon-6, and poly(1,4-phenylene terephthalamide), and copolymers of any of these], a thermotropic liquid crystalline polymer, a polysulfone, a polysulfide, a polyketone (including polyketones containing ether linking groups), an acrylonitrile-butadiene-styrene (ABS) copolymer, a chlorinated polymer [especially poly(vinyl chloride) and poly(vinylidene chloride)], and a thermoplastic elastomer, especially a thermoplastic block co(polyester-polyether), a block copolyolefin, a thermoplastic urethane or a thermoplastic elastomeric polymer blend.

“Thermotropic liquid crystalline polymer” herein means a polymer that is anisotropic when tested using the TOT test or any reasonable variation thereof, as described in U.S. Pat. No. 4,118,372, which is hereby incorporated by reference. Useful LCPs include polyesters, poly(ester-amides), and poly(ester-imides). One preferred form of polymer is “all aromatic”, that is all of the groups in the polymer main chain are aromatic (except for the linking groups such as ester groups), but side groups which are not aromatic may be present.

Useful thermosettable (i.e. readily crosslinkable) TPs include epoxy resins, melamine resins, phenolic resins, thermosetting polyurethane resins, and thermosetting polyester resins. These thermosetting resins may be combined with any of the specific TP resins or resin types listed above. In one preferred form of the invention these thermosettable resins are one or both of the first and second TPs. In another preferred form of the invention one of the first and second TPs is a thermosettable resin and the other is a classical TP.

More than two TPs may be bonded together, so long as an ISS is used between each of the different types of TPs to form a bond. For examples sheets of three different TPs may be bonded together by placing an ISS between each of the TP sheets, and then (melt) laminating the assembly to form melt bonds between the TPs and the ISSs. This may be carried out, for example, by heated calendar rolls of a belt press. The lamination of each TP to an ISS surface may be any combination of sequential or simultaneous heat bondings.

The melt bonding may be carried out in a number of ways. For instance, the ISS may be placed against one side of an injection mold and the first TP injection molded into the mold. After the first TP has solidified, the part containing the first TP may be removed and placed into a second mold where another surface of the ISS is exposed and the second TP injected into that mold to melt bond to the exposed ISS surface. After solidification of the second TP the bonded part may be removed from the mold. This process may be used with thermally crosslinkable resin(s) and the part held in a hot mold until the(ose) resin(s) crosslink (i.e. thermoset). In a variation of this process different polymers may be injection molded simultaneously onto the two surfaces of the ISS which is held in place in the mold. The ISS may be held in the proper position in the mold by a variety of known techniques such as vacuum, electrostatic charges, mechanically, etc.

In another process, the ISS may be laminated onto a surface of the first and/or second TP. For example, roll lamination may be used to bond the first and second TPs onto the surfaces of the ISS. This may be done sequentially or simultaneously, and is particularly useful when the first and/or second. TPs are sheets and/or films. Hot roll(s) calendering and/or a belt calendar may be used.

In another process, a compression mold is filled with the first TP and the ISS is laid on top of the first TP or is against one side of the mold. The mold is closed and heated (or is already hot) and pressure is applied. The second TP may then be contacted to the other surface of the ISS in a similar manner. Alternatively, the first TP is added to the mold, and the ISS is placed on top (or to the side of it) and the second TP is added so it will contact the other surface of the ISS. The mold is then closed and pressure is applied.

In another process, films of different TPs may be placed on either side of an ISS and then the assembly placed in a thermoforming machine wherein the TP films are adhered “through” the sheet, and a thermoformed shaped product is also produced. Multiple layers of TPs and ISSs may be employed in this and other similar processes, particularly those which use TP films.

It is also possible to use “welding” to melt bond the TPs, especially classical TPs, to the ISS (for descriptions of polymer welding see V. K. Stokes, ANTEC '89, p. 442-445; V. K. Stokes, Polym. Eng. Sci., vol. 40, p. 2175-2181 (2000); C. J. Nonhof, et al., Polym. Eng. Sci., vol. 36, p.1177-1183 (1996); Engineered Materials Handbook, Vol. 2, Engineering Plastics, ASM International, Metal Park, Ohio., 1988, p. 721 and 724-725; and U.S. Pat. Nos. 5,893,959 and 6,447,866; all of which are hereby included by reference), and preferably if the ISS is a MPS. For instance, a first TP may be melt bonded to the ISS by injection molding, and the second TP bonded to the other surface ISS by welding. Alternatively, both the first and second TPs may be welded to the ISS, either sequentially or simultaneously. Standard TP welding techniques, such as ultrasonic, spin, induction (either with a separate induction heatable element or inductive heating materials as polymer filler), vibrational, hot plate (e.g. hot tool) or laser welding may be used in these processes. Preferred welding methods are laser, vibration, and ultrasonic welding.

In polymer welding the surfaces to be joined are normally brought into contact with one another, and indeed are often pressed together. The same is true for methods herein using the ISS, but here the surfaces of the parts to be joined are intimately contacted with a surface of the ISS (which of course is in between the parts to be joined). In most applications, when it is attempted to weld dissimilar polymers, poor or no bonding between the dissimilar parts is usually obtained. However with the present method good bonds are usually obtained. These bonds are not only often strong, but they are often sealed well so that they are often relatively leak free (to liquids and gases), allowing these methods to be used to make systems which will handle liquids and/or gases, especially under pressure and/or vacuum.

Any combination of the above methods may be used. For example, the first TP may be laminated onto one surface of the ISS, and then the second surface of the ISS is melt bonded to the second TP in an injection molding or compression molding process. Other combinations will be obvious to the artisan.

Any single melt bonding process or combination of processes described above may used to prepare articles of the melt bonded assemblies, such as those described herein.

In the melt bonding process it is preferred that the rough surface features, whatever they are, of the ISS are not usually totally destroyed, and are often left fairly intact. For instance if the ISS comprises a TP, and temperature of the melt bonding process results in that TP being melted, the irregularities of the ISS may be lost. This may be avoided by a number of methods. The temperatures needed to cause the first and second TPs to melt may be low enough so that the melting point (if any) and/or the glass transition point of any TP comprising the ISS is higher than the melt bonding process temperature. Another method for avoiding loss of surface irregularities is for the ISS to be made from a crosslinked thermoset resin or another material with a high melting point, such as a metal. If the ISS comprises a TP, in some instances the TP may be so viscous that it flows little if at all above the melting/glass transition temperature. The viscosity can be increased by using a large amount filler, and/or using a TP which has a very high molecular weight, such as ultrahigh molecular weight polyethylene. For example, in one type of preferred ISS, preferably MPS, made from a thermoplastic, it is preferred that the thermoplastic have a weight average molecular weight of about 500,000 or more, more preferably about 1,000,000 or more. One useful type of TP which can be obtained in such high molecular weights is polyethylene, and it is a preferred TP for the ISS, preferably MPS. Another method to prevent the loss of rough surface features when bonding (a) TP(s) with higher melting points or glass transition temperatures is to minimize the time of exposure of the ISS to higher temperatures, so that the TP(s) “penetrate” the rough surface in a short period of time, which is not enough time for heat transfer to cause loss of the rough surface. Some of these methods may be combined to further retard loss of surface irregularities in the ISS.

Once the bonded structure is formed, in many instance the bonded interfaces are not the weak point in the structure. That is in many instances attempts to peel the two TPs from each other (TPs in the sense of during the melt bonding process) results in cohesive failure of one of the TPs or ISS, illustrating that material's inherent strength is the weak point of the bonded assembly.

The polymers described herein, either the TPs and/or the polymers of the ISS, but particularly the TPs, may contain materials normally found in such polymers, for example, fillers, reinforcing agents, antioxidants, pigments dyes, flame retardants, etc., in the amounts that are normally used in such compositions.

Joined TP articles are often useful because they may combine the best attributes of the two TPs being combined. For example automotive fuel tank bodies are often polyethylene because of its low cost and physical toughness, but other TP components, for instance polyoxymethylene and its copolymers, which are attached to the fuel tank need other attributes, such as stiffness, toughness, creep resistance, fatigue resistance, snap-fitability, antistatic properties, and fuel resistance. Joining of these components when they are made from different TPs may be done by the methods disclosed herein. Other uses taking advantage of these same properties, also in fuel systems, include fuel valves, fittings for fuel systems, fuel lines (rigid and flexible), fuel level indicator parts, fuel injectors, fuel pumps, and components of these items.

Another use involving poly(oxymethylene) and copolymers is conveyor links. Poly(oxymethylene) is a preferred material in conveyors due to its low coefficient of friction, high wear resistance and its mechanical strength. In some areas it is desirable to have a high friction material such as a thermoplastic elastomer as the top surface of the poly(oxymethylene) conveyor links. The present process provides such a combination.

Another useful type of TP polymer pair which may be bonded together using an ISS is a relatively hard TP and a relatively soft TP. Relatively soft TPs can include plasticized materials such as plasticized poly(vinyl chloride), thermoplastic elastomers, and other similar materials. Hard TPs include typical semicrystalline and glassy TPs such as polyoxymethylene, poly(ethylene terephthalate), nylon-6 and -6,6. Thus the soft polymer in this combination can provide a soft touch for a comfortable feel for example on power tool handles, tooth brushes, sports equipment, surfaces which may be impacted such as dashboards, and various types of knobs, or can provide high friction surfaces for conveyors, rollers, handles, linings for containers or storage zones, for sealing things such as bottle lids, valves, and connectors, and sound or impact deadening, such as liners for appliances such as dishwashers, clothes washers and clothes dryers. In all cases the hard polymer may provide higher strength or other good structural properties for the use involved.

Another use is bonding a TP to a TP barrier resin such as the Selar® barrier resins available from E. I. DuPont de Nemours and Co., Inc., Wilmington, Del. 19898, USA. Thus a somewhat permeable resin such as polyethylene may be bonded to a barrier resin using an ISS to make the part less permeable to certain materials such as water or oxygen. This may be useful in “containers” such as pipes, bottles, tanks, carboys, drums, and similar items. The barrier resin may be bonded to the inside or outside of the container, or may be an intermediate layer.

Herein melting points and glass transition temperatures are measured by ASTM Method D3418. Melting points are taken as the maximum of the melting endotherm, and glass transition temperatures are taken as the midpoint of the transition. Melting points and glass transition temperatures are measured on a second heat.

In the (Comparative) Examples, the following abbreviations and materials are used:
Alathon® M6060, an HDPE available from Equistar Chemicals, Houston, Tex., USA.
Delrin® 100—a high viscosity acetal homopolymer available from E. I. DuPont de Nemours & Co., Inc, Wilmington, Del., USA.
Delrin® 500P—a medium viscosity acetal homopolymer available from E. I. DuPont de Nemours & Co., Inc, Wilmington, Del., USA.
Delrin® 511 P—a nucleated medium viscosity acetal homopolymer available from E. I. DuPont de Nemours & Co., Inc, Wilmington, Del., USA.
HDPE—high density polyethylene.
Hytrel® 4069—a nominal Shore D hardness of 60 poly(butylene terephthalate) poly(tetramethylene ether glycol terephthalate) thermoplastic elastomer available from E. I. DuPont de Nemours & Co., Inc, Wilmington, Del., USA.
LCP1—a copolymer made from 3 parts 4,4′-biphenol, 37 parts ethylene glycol, 40 parts terephthalic acid and 60 parts 4-hydroxybenzoic acid, wherein all parts are molar parts.
LCP2—a copolymer made from 2 parts 4,4′-biphenol, 28 parts ethylene glycol, 30 parts terephthalic acid, 50 parts 4-hydroxybenzoic acid, and 20 parts 4-hydroxy-2-napthoic acid, wherein all parts are molar parts.
Lupolen® 4261 AQ444 is a HDPE (natural color) available from Basell Nev., 2132 MS Hoofddorp, Netherlands.
P—pressure.
PP—polypropylene, Profax® 6823 sold by Basell Polyolefins, Elkton, Md., USA.
Sontara® 8000—a poly(ethylene terephthalate) spunlaced, hydroentangled NWF, 40 g/m², available from E. I. DuPont de Nemours & Co., Inc, Wilmington, Del., USA.
Ponaflex® S650A—a block styrene-butadiene-styrene thermoplastic elastomer with a Shore A hardness of 50 available from Plastolen GmbH, Germany.
Teslin® SP700—a 0.18 mm thick microporous sheet containing high molecular weight polyethylene and large amounts of precipitated silica available from PPG Industries, Pittsburgh, Pa., USA (a similar suitable material may be available under the tradename MIST®).
Tyvek®—A spunbonded polyethylene nonwoven fabric available from E. I. DuPont de Nemours & Co., Inc, Wilmington, Del., USA.

Adhesion testing was done in a (0°) shearing mode. Using an Instron® 4024 loadframe machine, the end of Material B was clamped in the upper jaw. Material A was clamped in the lower jaw after removing some of Material B mechanically from this section of the assembly so that the lower jaw grabbed onto Material A only. Pulling speed was 50 mm/min.

### EXAMPLES 1-4

Samples were prepared on a conventional two-component two barrel injection molding machine (Engel 2C ES500H/200 1750HL-2F). The barrels were arranged horizonatally at right angles to one another. The NWF was inserted into one side (fixed) of the cavity, the mold closed and Material A was injected into the cavity. One side on the injection molded part was now covered by the NWF. The mold opened, turned (rotated) and closed again, and the NWF (“backed” by A) now formed one of the cavity surfaces. Material B was now injection molded into the cavity, thereby covering and melt bonding to the second side of the NWF. Material B-and the NWF strip were molded down the center of the width of Material A, and one end of Material B was molded past the end of Material A forming a tab for adhesion testing. After cooling the part was removed. In this instance, Material A's shape was a rectangular plaque, with the dimensions 140×40×3 mm. The NWF was a rectangular strip about 140×40 mm, so it covered a larger molded surface of A. The shape of B was plaque of dimensions 125×20×2 mm, so it covered only part of the area of A. Materials and results are shown in Table 1. Table 1 a gives the injection molding parameters in these Examples. Mold temperatures were all 74° C.

TABLE 1

| | | | | Max. | |
|---|---|---|---|---|---|
| | | | | Force | |
| Ex. | Material A | Material B | NWF | (N) | Failure Mode |
| 1 | Delrin ® 511P | Hytrel ® | Sontara ® | 314 | Cohesive failure of |
| | | 4069 | | | NWF |
| 2 | Delrin ® 500P | Alathon ® | Sontara ® | 1213 | Breakage of HDPE - |
| | | 6060 | | | no adhesive failure |
| 3 | Delrin ® 511P | Alathon ® | Sontara ® | 1213 | Breakage of HDPE - |
| | | 6060 | | | no adhesive failure |
| 4 | Delrin ® 511P | Alathon ® | Tyvek ® | 874 | Cohesive failure of |
| | | 6060 | | | NWF |

TABLE 1a

| | Melt | | | Hold |
|---|---|---|---|---|
| | Temp. | Injection P | Hold P | Time |
| Polymer | ° C. | MPa | MPa | sec |
| Delrin ® 511P | 212 | 65 | 90 | 25 |
| Delrin ® 500P | 212 | 65 | 100 | 25 |
| Hytrel ® 4069 | 225 | 237 | 100 | 20 |
| HDPE | 240 | 237 | 100 | 20 |

### EXAMPLES 5-10

These combinations were made and tested in the same way as described for Examples 14. Materials and results are shown in Table 2. Molding conditions are given in Table 2a. Mold temperatures were all 74° C.

TABLE 2

| | | | | Max. | |
|---|---|---|---|---|---|
| Ex | Material A | Material B | MPS | Force (N) | Failure Mode |
| 5 | Delrin ® | Ponaflex ® | Teslin ® | 45^{a} | Cohesive failure |
| | 511P | S650A | SP700 | | Ponaflex ® |
| 6 | Delrin ® | Ponaflex ® | Teslin ® | 45^{a} | Cohesive failure |
| | 500P | S650A | SP700 | | Ponaflex ® |
| 7 | Delrin ® | Hytrel ® | Teslin ® | 488 | No failure after |
| | 511P | 4069 | SP700 | | 800% elongation |
| 8 | Delrin ® | HDPE | Teslin ® | 1231 | Cohesive failure |
| | 500P | | SP700 | | HDPE - no |
| | | | | | adhesive failure |
| 9 | Delrin ® | HDPE | Teslin ® | 1258 | Cohesive failure |
| | 511P | | SP700 | | HDPE - no |
| | | | | | adhesive failure |
| 10 | HDPE | Delrin ® | Teslin ® | 2264^{a} | Cohesive failure |
| | | 511P | SP700 | | HDPE - no |
| | | | | | adhesive failure |

^{a}Results may be influenced by slippage from jaws. (As slippage decreases results may be higher.)

TABLE 2a

| | | Melt | | | Hold |
|---|---|---|---|---|---|
| | | Temp. | Injection P | Hold P | Time |
| Ex. | Material | ° C. | MPa | MPa | sec |
| 5 | A | 212 | 65 | 90 | 25 |
| | B | 240 | 237 | 100 | 20 |
| 6 | A | 212 | 65 | 90 | 25 |
| | B | 240 | 237 | 100 | 20 |
| 7 | A | 212 | 65 | 90 | 25 |
| | B | 225 | 237 | 50 | 20 |
| 8 | A | 212 | 65 | 90 | 25 |
| | B | 240 | 237 | 100 | 20 |
| 9 | A | 212 | 65 | 90 | 25 |
| | B | 240 | 237 | 100 | 20 |
| 10 | A | 212 | 65 | 90 | 25 |
| | B | 240 | 237 | 50 | 20 |

### COMPARATIVE EXAMPLE A

Placed a rectangular piece of LCP1 film (about 2.5×6.4 cm×about 75-100 μm thick) ans a similar sized film of HDPE together between the sealing bars of a heat seal machine. The machine was capable of heating the films and impacting sealing under pressure (Impact heat sealer “Impulse Autosealer”, 600 W, made by TEW Electric Heating Co., Lt., Taiwan). Turned on the heating and clamping mechanism, and rapid heating and pressure were applied for about 1.5-2 sec. After removal from the machine, the films fell apart (i.e. there was no adhesion).

### EXAMPLE 15

A 5×5 cm×50 μm thick piece of Sontara® 8000 having a lot of fuzzy fibers exposed on the surfaces was placed between a film of LCP1 and a film of HDPE 2, each 5×10 cm×about 100 μm thick. The composition was placed between the sealing bars of the heat seal machine and the heat-clamping mechanism was turned on for about 1-2 sec. After removal from the machine the films of LCP and HDPE bonded to each other through the intermediate layer of Sontara®. The two films could not be separated by hand, in a peeling effort, until the intermediate NWF failed cohesively.

### EXAMPLE 16

The procedure of Example 15 was followed except Delrin® 100 film about 100 μm thick was used in place of the LCP1 film. After removal from the machine the films of Delrin® 100 and HDPE bonded to each other through the intermediate layer of Sontara®. The two films could not be separated by hand, in a peeling effort, until the intermediate NWF failed cohesively.

### COMPARATIVE EXAMPLE B

The procedure of Comparative Example A was followed except a film of Delrin® 100 about 200 μm thick was used in place of the LCP1 film. After removal from the machine, the films fell apart (i.e. there was no adhesion).

### EXAMPLES 17-22

Square films (about 15.2×15.2 cm) of TPs each about 200 μm thick were placed on either side of a NWF. The composition was between the platens (and sheets of AI foil coated with a nonstick material) of a Pasadena Press (Model SP210C, now Tec-Tool Inc., Edinburgh, Ind., USA) whose platens had been preheated to 205-210® C. for LCP1 and 220° C. for Delrin®100. Temperatures for other polymers were set so the polymers would melt. After a 2 min preheat, pressure (about 6.9 to about 13.8 MPa) was applied for about 2 min, and then the platens were cooled by circulation of cold water. After removal of the samples they were hand tested for adhesion. Compositions and results are given in Table 3. Total thickness of these laminates was about 350-300 μm.

TABLE 3

| Ex. | TP1 | NWF | TP2 | Bonding Result |
|---|---|---|---|---|
| 13 | LCP1 | Sontara ® | HDPE | Cohesive Sontara ® |
| | | 8000 | | failure |
| 14 | LCP2 | Sontara ® | PP | Good bond strength |
| | | 8000 | | |
| 15 | Delrin ® | Sontara ® | HDPE | Excellent bond |
| | 100 | 8000 | | strength |
| 16 | Delrin ® | Sontara ® | LCP2 | Excellent bond |
| | 100 | 8000 | | strength |
| 17 | Hytrel ® | Sontara ® | PP | Excellent bond |
| | 4069 | 8000 | | strength |
| 18 | LCP2 | * | PP | Good bond strength |

*The “NWF” was a cotton cheese cloth, temperature 210-215° C.

### COMPARATIVE EXAMPLE C

Using the procedure of Examples 13-88, a poly(ethylene terephthalate) film was placed between a layer of LCP2 and a layer of Delrin® 100, and placed in the Pasadena Press. After removal from the press, there was no adhesion between the layers.

### COMPARATIVE EXAMPLE D

Using the procedure of Examples 13-18 a layer of Tyvek® polyethylene NWF made for envelopes was placed between two films of Delrin® 100. After applying heat and pressure in the Pasadena Press, and removing from the press, there was no adhesion between the layers. The Tyvek® NWF had melted.

### EXAMPLE 19

Following the procedure of Examples 13-18, a film of LCP2 (125 μm thick) and Sontara® 8000 were heated and pressed in the Pasadena Press, and then cooled and removed. A layer of HDPE (100-125 μm thick) was then placed against the Sontara® side (the side opposite the LCP2) of laminate and the construction was then heated and pressed in the Pasadena Press. After removal form the press both the LCP and HDPE films were well bonded together.

### EXAMPLE 20

Similar to the procedure of Examples 13-18 a square, approximately 30.5×30.5 cm, piece of Sontara® 8000 was placed between a film of LCP2 and a film of HDPE. After applying heat and pressure in the press, the laminate was removed. The laminate was placed in a thermoforming unit (Hydrotrim® Model No.1620 Thermoformer, made by Hydrotrim Corp., Valley Cottage, N.Y., USA), heated to about 300° C. and thermoformed. The shape of the mold was a small dish (5.1 cm diameter and 2.5 cm deep). The laminate thermoformed into the shape of the mold, and replicated the mold cavity.

### EXAMPLES 21-31

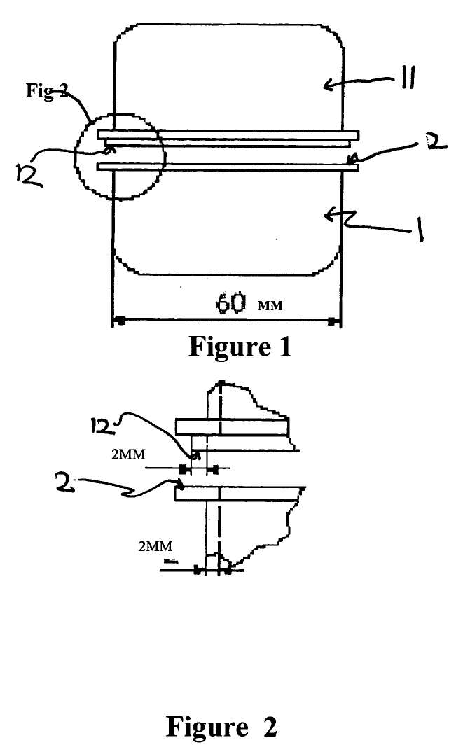

The polymers to be joined in these Examples were Delrin® 511 P and Lupolen® 4261. They were injection molded into the test parts shown in FIG. 1, with the Delrin® being 1 and the Lupolen® being 11. In FIG. 1, 1 and 11 are side views of square “half boxes”, about 60 mm wide on a side. The depth of each box from the open side surface is about 30 mm. All of the edges of the box are rounded, and wall thickness is approximately 2 mm. 1 has a mating surface 2, which is about 6 mm wide. 11 has a mating surface 12, which is about 2 mm wide and is raised about 2 mm from the basal surface of the open face of the box. All dimensions shown in FIG. 1 are in mm. A detailed view of the sections near 11 and 12 in FIG. 1 are also shown in FIG. 2.

A piece of Teslin® 700SP was cut to the shape of mating surface 2 (this piece of Teslin® had a tab on it so that a robot arm could place it in position in the mold), and 1 was injection molded so that the Teslin® was an insert in the mold (on mating surface 2) and when removed from the mold the Delrin® part 1 had the Teslin® stuck to the mating surface 2. 11 was molded from the Lupolen® and mating surface 12 was placed in contact with Teslin® attached to 2. This assembly was then placed in a Branson® 2400 vibration welding machine (Branson Ultrasonic Corp., Danbury, Conn. 06813, USA). This machine operated at 240 Hz, with a maximum amplitude of 1.75 mm (peak to peak) and a closing pressure of 1000-6000 N.

After welding, two holes were drilled in the part away from the welded surfaces and fittings were attached so that the part could be filled with oil and pressurized internally. The part was placed in a tester which could gradually pressurize the part interior to up to 160 bars, and which could be heated to 150° C., although the present Examples were tested at 23° C. Welding conditions and test results are given in Table 4. In Table 4, the following definitions apply:

“Burst Pressure” means the test pressure at which the weld failed;

“Pressure equip.” means the pressure in the Branson® 2400 pneumatic cylinder;

“Force” is the pressure used in forming the welds;

“Pressure joint” is actual pressure in the weld joint;

“Welding time” is the number of seconds used to form the weld; and

“Amplitude” is the amplitude of the vibration, and “Collapse” is the distance the piece collapsed due to the melting of the polymers and formation of the weld.

Weldings done under similar conditions with both pieces being of similar material, for example Delrin® or Lupolen®, without the Teslin® present showed good welding had been achieved. However, when Delrin® and Lupolen® (i.e. dissimilar materials) were welded together in the absence of Teslin®, the “welds” formed had essentially no strength.

Weldings also done under similar conditions in which the Teslin® was not stuck to the Delrin® part but was merely inserted between the mating surfaces 2 and 12 when the assembly was put together had good weld strengths.

TABLE 4

| | Burst | Pressure | | Pressure | Welding | Am- | |
|---|---|---|---|---|---|---|---|
| | pressure | equip. | Force | joint | time | plitude | Collapse |
| Ex. | (bar) | (bar) | (N) | (MPa) | (s) | (mm) | (mm) |
| 21 | 5.0 | 2.0 | 750 | 1.6 | 6 | 1.50 | 1.1 |
| 22 | 4.2 | 2.0 | 750 | 1.6 | 4 | 1.75 | 0.9 |
| 23 | 3.8 | 2.0 | 750 | 1.6 | 3 | 2.00 | 0.8 |
| 24 | 4.1 | 1.5 | 1000 | 2.1 | 7 | 1.25 | 0.9 |
| 25 | 4.0 | 1.5 | 1000 | 2.1 | 5 | 1.50 | 1.2 |
| 26 | 4.4 | 1.5 | 1000 | 2.1 | 4 | 1.75 | 1.1 |
| 27 | 2.5 | 1.9 | 1500 | 3.2 | 7 | 1.25 | 0.4 |
| 28 | 5.2 | 1.9 | 1500 | 3.2 | 4 | 1.50 | 1.0 |
| 29 | 4.0 | 1.9 | 1500 | 3.2 | | 1.75 | 1.2 |
| 30 | 5.5 | 3.0 | 3100 | 6.6 | 3 | 1.50 | 1.1 |
| 31 | 4.4 | 3.0 | 3100 | 6.6 | 2.5 | 1.75 | 1.1 |

### EXAMPLES 32-37

In these examples Delrin® 511 P BK402 (Delrin® 511 P containing 0.3 weight percent carbon black) was bonded to Lupolen® 4261 AQ444 (natural colored HDPE) using Teslin® SP700 as the microporous layer. In this instance both the Delrin® and Lupolen® were injection molded into half boxes 1, and the Teslin® was “attached” during the injection molding process to the Delrin®part, as described in Examples 21-31. Mating surfaces 2 on the Delrin® part (which as covered by the Teslin®) and the Lupolen® were brought into contact with the Teslin® sheet between them.

The bonding method was polymer laser welding. A Novolas® C laser welder (Leister Process Technologies, 6060 Sarnen, Switzerland) was used. This machine was equipped with a 40 W (maximum power) 940 nm diode laser, and was capable of a maximum welding speed of 150 mm/s. The assembly to be welded was clamped together and the surfaces to be bonded were exposed to the laser. The laser beam first contacted the assembly at the surface of the Lupolen® HDPE, and then presumably passing through that polymer to the Teslin®, and then remaining laser power being absorbed by the black Delrin®D. Welding conditions and results are given in Table 5. In Table 5, the following definitions apply:
“Laser Power” is the power setting of the laser in watts;
“Max. speed” is the speed of the laser beam over the weld in mm/s;
“Distance” is the distance from the last laser lens element to the surface of the Delrin in mm;
“Joint Width” is the width of the laser beam in mm;
“Pres. Joint” is the pressure being applied to the joint being formed; and

“Burst Pressure” is the same as defined in Table 4.

In all cases, there was no collapse of the polymer when forming the weld. In all cases, burst pressures were determined as described in Examples 21-31.

TABLE 5

| | | | | Joint | Pres. | Burst |
|---|---|---|---|---|---|---|
| | Laser Power | Max. speed | Distance | width | joint | pressure |
| Ex. | (W) | (mm/s) | (mm) | (mm) | (MPa) | (bar) |
| 32 | 38 | 10 | 61 | | 0.7 | 4.8 |
| 33 | 40 | 8 | 73 | 1.25 | 0.7 | 6.0 |
| 34 | 40 | 8 | 73 | | 0.7 | 6.7 |
| 35 | 40 | 8 | 73 | 1.0 | 1.4 | 7.0 |
| 36 | 40 | 8 | 74 | | | 6.3 |
| 37 | 40 | 8 | 72 | | 1.4 | 5.5 |

### EXAMPLE 38

Burst pressure test assemblies were vibration welded in a manner similar to that used in Examples 21-31. Pressure equip. was 1.9 bar, Force was 1500 N, Pressure joint was 3.2 MPa, Welding time was 6 s, Amplitude was 1.50 mm and Collapse was 1.6 mm. Burst pressure for the assembly on the as molded part was 8.0 bars. Five assemblies were aged in M15 fuel (reported to have a composition of 42.5% toluene, 42.5% n-octane and 15% methanol, all percents are volume percents) for 1000 h at 60° C. After removing the excess fuel from the assemblies, they were tested for burst pressure. The average burst pressure of the five assemblies was 6.5±1.5 bars (standard deviation). This excellent retention of burst pressure illustrates that these vibration welded bonds have good stability in M15 fuel and are suitable for use in components in fuel containing systems.

It is therefore, apparent that there has been provided in accordance with the present invention, an article and process for bonding different thermoplastic polymers using a thermoplastic sheet having irregular surfaces placed therebetween that fully satisfies the aims and advantages hereinbefore set forth. While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

1. An article, comprising, a sheet comprising a thermoplastic or crosslinked thermoset resin having a first side and a second side, a first thermoplastic melt bonded to said first side of said sheet, and a second thermoplastic melt bonded to said second side of said thermoplastic sheet, and
provided that:
said first side and said second side have irregular surfaces; and
said first thermoplastic and said second thermoplastic are different.

2. The article as recited in claim 1 wherein said sheet is a microporous sheet.

3. The article as recited in claim 2 wherein said microporous sheet comprises ultrahigh molecular weight polyethylene and a filler.

4. The article as recited in claim 1 wherein said sheet is a fabric.

5. The article as recited in claim 4 wherein said fabric is a nonwoven fabric.

6. The article as recited in claim 5 wherein said nonwoven fabric is spunbonded or melt blown.

7. The article as recited in claim 1 wherein one or both of said first and second thermoplastics are independently chosen from the group consisting of poly(oxymethylene) or a copolymer thereof, a polyester, a polyamide, a polyolefin, a polystyrene/poly(phenylene oxide) blend, a polycarbonate, a fluoropolymer, a polysulfide, a polyetherketone, a poly(etherimide), an acrylonitrile-1,3-butadinene-styrene copolymer, a (meth)acrylic polymer, a thermoplastic elastomer, a thermotropic liquid crystalline polymer, and a chlorinated polymer.

8. The article as recited in claim 1 wherein:
said first polymer is poly(oxymethylene) or a copolymer thereof, and said second polymer is chosen from the group consisting of a polyolefin, a poly(meth)acrylate, a fluorinated polymer, a polyester, a polyamide, a thermotropic liquid crystalline polymer, a polycarbonate, a polysulfone, a polysulfide, a polyketone, an acrylonitrile-1,3-butadiene-styrene copolymer, a chlorinated polymer, and a thermoplastic elastomer; or
said first polymer is a polyester, and said second polymer is selected from the group consisting of a polyolefin, a poly(meth)acrylate, a polycarbonate, a fluorinated polymer, a second polyester, a polyamide, a thermotropic liquid crystalline polymer, a polysulfone, a polysulfide, a polyketone, an acrylonitrile-1,3-butadiene-styrene copolymer, a chlorinated polymer, and a thermoplastic elastomer; or
said first polymer is a polyamide, and said second polymer is selected from the group consisting of a polyolefin, a poly(meth)acrylate, a polycarbonate, a fluorinated polymer, a polyester, a second polyamide, a thermotropic liquid crystalline polymer, a polysulfone, a polysulfide, a polyketone, an acrylonitrile-1,3-butadiene-styrene copolymer, a chlorinated polymer, and a thermoplastic elastomer; or
said first polymer is a thermotropic liquid crystalline polymer and said second polymer is selected from the group consisting of a polyolefin, a poly(meth)acrylate, a polycarbonate, a fluorinated polymer, a polyester, a polyamide, a second thermotropic liquid crystalline polymer, a polysulfone, a polysulfide, a polyketone, an acrylonitrile-1,3-butadiene-styrene copolymer, a chlorinated polymer, and a thermoplastic elastomer; or
said first polymer is a fluorinated polymer, and said second polymer is selected from the group consisting of a polyolefin, a poly(meth)acrylate, a polycarbonate, a second fluorinated polymer, a polyester, a polyamide, a thermotropic liquid crystalline polymer, a polysulfone, a polysulfide, a polyketone, an acrylonitrile-1,3-butadiene-styrene copolymer, a chlorinated polymer, and a thermoplastic elastomer.

9. The article as recited in claim 1 wherein one or both of said first and said second polymers is thermosettable.

10. The article as recited in claim 1 which comprises some or all of a fuel system.

11. The article as recited in claim 10 which is part of one or more of a fuel tank, fuel valve, a fuel fitting, a fuel line, a fuel level indicator part, a fuel injector, or a fuel pump.

12. The article as recited in claim 10 wherein said first polymer is poly(oxymethylene) or a copolymer thereof.

13. The article as recited in claim 1 which comprises some or all of a conveyor and wherein said first polymer is poly(oxymethylene) or a copolymer thereof.

14. The article as recited in claim 1 wherein said first polymer is relatively hard and said second polymer is relatively soft.

15. The article as recited in claim 14 which comprises a power tool handle, tooth brush, a piece of sports equipment, a surface which is designed to be impacted, a knob, a part designed to provide high friction surface, an item containing a sealing surface, or an item designed to deaden sound or impact.

16. The article as recited in claim 1 wherein said first thermoplastic is a barrier resin.

17. A process for forming an article in which a first thermoplastic and a second thermoplastic are bonded to each other, comprising:
(a) melt bonding said first thermoplastic to a first side of sheet comprising a thermoplastic or crosslinked thermoset resin; and
(b) melt bonding said second thermoplastic to a second side of said sheet; and
provided that:
said first side and said second side have irregular surfaces; and
said first thermoplastic and said second thermoplastic are different.

18. The process as recited in claim 17 wherein said sheet is a microporous sheet.

19. The process as recited in claim 18 wherein said microporous sheet comprises ultrahigh molecular weight polyethylene and a filler.

20. The process as recited in claim 1 wherein said sheet is a fabric.

21. The process as recited in claim 20 wherein said fabric is a nonwoven fabric.

22. The process as recited in claim 21 wherein said nonwoven fabric is spunbonded or melt blown.

23. The process as recited in claim 17 wherein one or both of said first and second thermoplastics are independently chosen from the group consisting of poly(oxymethylene) or a copolymer thereof, a polyester, a polyamide, a polyolefin, a polystyrene/poly(phenylene oxide) blend, a polycarbonate, a fluoropolymer, a polysulfide, a polyetherketone, a poly(etherimide), an acrylonitrile-1,3-butadinene-styrene copolymer, a (meth)acrylic polymer, a thermoplastic elastomer, a thermotropic liquid crystalline polymer, and a chlorinated polymer.

24. The process as recited in claim 17 wherein:
said first polymer is poly(oxymethylene) or a copolymer thereof, and said second polymer is chosen from the group consisting of a polyolefin, a poly(meth)acrylate, a fluorinated polymer, a polyester, a polyamide, a thermotropic liquid crystalline polymer, a polycarbonate, a polysulfone, a polysulfide, a polyketone, an acrylonitrile-1,3-butadiene-styrene copolymer, a chlorinated polymer, and a thermoplastic elastomer; or
said first polymer is a polyester, and said second polymer is selected from the group consisting of a polyolefin, a poly(meth)acrylate, a polycarbonate, a fluorinated polymer, a second polyester, a polyamide, a thermotropic liquid crystalline polymer, a polysulfone, a polysulfide, a polyketone, an acrylonitrile-1,3-butadiene-styrene copolymer, a chlorinated polymer, and a thermoplastic elastomer; or
said first polymer is a polyamide, and said second polymer is selected from the group consisting of a polyolefin, a poly(meth)acrylate, a polycarbonate, a fluorinated polymer, a polyester, a second polyamide, a thermotropic liquid crystalline polymer, a polysulfone, a polysulfide, a polyketone, an acrylonitrile-1,3-butadiene-styrene copolymer, a chlorinated polymer, and a thermoplastic elastomer; or
said first polymer is a thermotropic liquid crystalline polymer and said second polymer is selected from the group consisting of a polyolefin, a poly(meth)acrylate, a polycarbonate, a fluorinated polymer, a polyester, a polyamide, a second thermotropic liquid crystalline polymer, a polysulfone, a polysulfide, a polyketone, an acrylonitrile-1,3-butadiene-styrene copolymer, a chlorinated polymer, and a thermoplastic elastomer; or
said first polymer is a fluorinated polymer, and said second polymer is selected from the group consisting of a polyolefin, a poly(meth)acrylate, a polycarbonate, a second fluorinated polymer, a polyester, a polyamide, a thermotropic liquid crystalline polymer, a polysulfone, a polysulfide, a polyketone, an acrylonitrile-1,3-butadiene-styrene copolymer, a chlorinated polymer, and a thermoplastic elastomer.

25. The process as recited in claim 17 wherein one or both of said first and said second polymers is thermosettable.

26. The process as recited in claim 17 wherein at least part of said melt bonding is carried out in an injection mold, a roll laminator, a compression mold, or a thermoforming machine.

27. The process as recited in claim 17 wherein at least part of said melt bonding is a welding process.

28. The process as recited in claim 27 wherein said welding is laser, vibration or ultrasonic welding.
